(19) United States
(12) Patent Application Publication
(10) Pub. No.: US 2017/0085758 A1
(43) Pub. Date: Mar. 23, 2017

(54) CAMERA MODULE AND METHOD FOR MANUFACTURING THE CAMERA MODULE

(71) Applicant: Cheng Uei Precision Industry Co., Ltd., New Taipei City (TW)

(72) Inventors: Jui Hsiang Lo, New Taipei City (TW); Yu Ting Shih, New Taipei City (TW)

(21) Appl. No.: 14/938,703

(22) Filed: Nov. 11, 2015

(30) Foreign Application Priority Data
Sep. 18, 2015 (TW) 104131050

(51) Int. Cl. H04N 5/225

(52) U.S. Cl. CPC H04N 5/2254; H04N 5/2253

(57) ABSTRACT

A camera module includes a circuit board, a lens socket, a lens assembly and an image-sensing chip. The circuit board defines a nonopaque area. The lens socket is mounted on a top surface of the circuit board and covers the nonopaque area. The lens assembly is assembled in the lens socket. The lens assembly includes at least one imaging lens which makes an optical axis formed by the lens assembly penetrate through the nonopaque area. The image-sensing chip is fastened to a bottom surface of the circuit board and is electrically connected with the circuit board. The image-sensing chip is located at the optical axis. The method for manufacturing the camera module is described hereinafter. Prepare a circuit board. Prepare an image-sensing chip. Prepare a lens socket and a lens assembly.

The present application is based on, and claims priority form, Taiwan Patent Application No. 104131050, filed Sep. 18, 2015, the disclosure of which is hereby incorporated by reference herein in its entirety.

### BACKGROUND OF THE INVENTION

1. Field of the Invention

The present invention generally relates to a camera module, and more particularly to a camera module applied in a portable electronic device and a method for manufacturing the camera module.

2. The Related Art

In order to cater to a consumer market demand, a portable electronic device need have more functions, and working hours and a cost of manufacturing the portable electronic device need be lowered. A camera module applied in the portable electronic device need be developed towards a miniaturized and modularized direction.

Referring to FIG. 9, a camera module 101 in a first prior art includes a circuit board 201, a lens assembly 301 disposed on a top surface of the circuit board 201, and a light-sensing chip 501 assembled between the lens assembly 301 and the circuit board 201. A package layer 502 is formed outside the light-sensing chip 501 by a chip scale package technology. The package layer 502 together with the light-sensing chip 501 is soldered on the circuit board 201 by a surface mount technology. The package layer 502 is a ceramic package layer or a plastic package layer. The lens assembly 301 includes a lens socket 304, at least one imaging lens 302 mounted to a top end of the lens socket 304, and a filter 303 disposed between the imaging lens 302 and the light-sensing chip 501.

Though a total height H₁ of the camera module 101 is wished to be minimized, a height h₃ between a top end of the lens assembly 301 and a top surface of the light-sensing chip 501 must be kept in a predetermined height on account of an optical design limitation of the lens assembly 301. The total height H₁ of the camera module 101 depends on a height h₄ between a bottom surface of the camera module 101 and the top surface of the light-sensing chip 501. The light-sensing chip 501 has the package layer 502 that makes the total height H₁ of the camera module 101 hardly decreased.

Referring to FIG. 10, a camera module 102 in a second prior art includes a circuit board 202, a lens assembly 305 disposed on a top surface of the circuit board 202, a light-sensing chip 503 assembled between the lens assembly 305 and the circuit board 202, and a bearing seat 504. In order to decrease a height h₅ between a bottom surface of the camera module 102 and a top surface of the light-sensing chip 503, a bottom of the bearing seat 504 defines a recess 505, and the light-sensing chip 503 is assembled in the recess 505 of the bearing seat 504. The light-sensing chip 503 together with the bearing seat 504 is mounted on the circuit board 202. Though a total height H₂ of the camera module 102 is decreased, the camera module 102 still hardly satisfies a thickness requirement of the current portable electronic device.

Referring to FIG. 11, a camera module 103 in a third prior art includes a circuit board 203, a lens assembly 306 disposed on a top surface of the circuit board 203, and a light-sensing chip 506 assembled between the lens assembly 306 and the circuit board 203. In order to further decrease a height h₆ between a bottom surface of the camera module 103 and the top surface of the light-sensing chip 506, the circuit board 203 defines an opening 204, and the light-sensing chip 506 is received in the opening 204. However, though a total height H₃ of the camera module 103 is decreased, the light-sensing chip 506 is just adhered to a periphery wall of the opening 204 of the circuit board 203, so the light-sensing chip 506 easily breaks away from the circuit board 203 when an external force is exerted on the camera module 103. If a retaining block 307 is disposed under the light-sensing chip 506 for preventing the light-sensing chip 506 breaks away from the circuit board 203 when the external force is exerted on the camera module 103, the total height H₃ of the camera module 103 will be increased.

### SUMMARY OF THE INVENTION

An object of the present invention is to provide a camera module and a method for manufacturing the camera module. The camera module includes a circuit board, a lens socket, a lens assembly and an image-sensing chip. The circuit board defines a nonopaque area. The lens socket is mounted on a top surface of the circuit board and covers the nonopaque area. The lens assembly is assembled in the lens socket. The lens assembly includes at least one imaging lens which makes an optical axis formed by the lens assembly penetrate through the nonopaque area. The image-sensing chip is fastened to a bottom surface of the circuit board and is electrically connected with the circuit board. The image-sensing chip is located at the optical axis.

The method for manufacturing the camera module is described hereinafter. Prepare a circuit board. The circuit board defines a nonopaque area. Prepare an image-sensing chip. The image-sensing chip is assembled to a bottom surface of the circuit board to make the image-sensing chip electrically connected with the circuit board and corresponding to the nonopaque area. Prepare a lens socket and a lens assembly. The lens assembly is assembled in the lens socket. The lens socket is mounted to a top surface of the circuit board to make an optical axis formed by the lens assembly pass through the nonopaque area.

As described above, the circuit board is disposed between the lens assembly and the image-sensing chip of the camera module, so a total height of the camera module is decreased. As a result, the camera module easily satisfies a thickness requirement of a current portable electronic device.

### BRIEF DESCRIPTION OF THE DRAWINGS

The present invention will be apparent to those skilled in the art by reading the following description, with reference to the attached drawings, in which:

FIG. 1 is a sectional view of a camera module in accordance with a first embodiment of the present invention;

FIG. 2 is a sectional view of a camera module in accordance with a second embodiment of the present invention;

FIG. 3 is a sectional view of a camera module in accordance with a third embodiment of the present invention;

FIG. 4 is a partially exploded view of the camera module in accordance with the present invention;

FIG. 5 are sectional views showing a process of manufacturing the camera module in accordance with the first embodiment of the present invention;

FIG. 6 are sectional views showing the process of manufacturing the camera module in accordance with the second embodiment of the present invention;

FIG. 7 are sectional views showing the process of manufacturing the camera module in accordance with the third embodiment of the present invention;

FIG. 8 are sectional views showing a process of adhering an image-sensing chip to a circuit board;

FIG. 9 is a sectional view of a camera module in a first prior art;

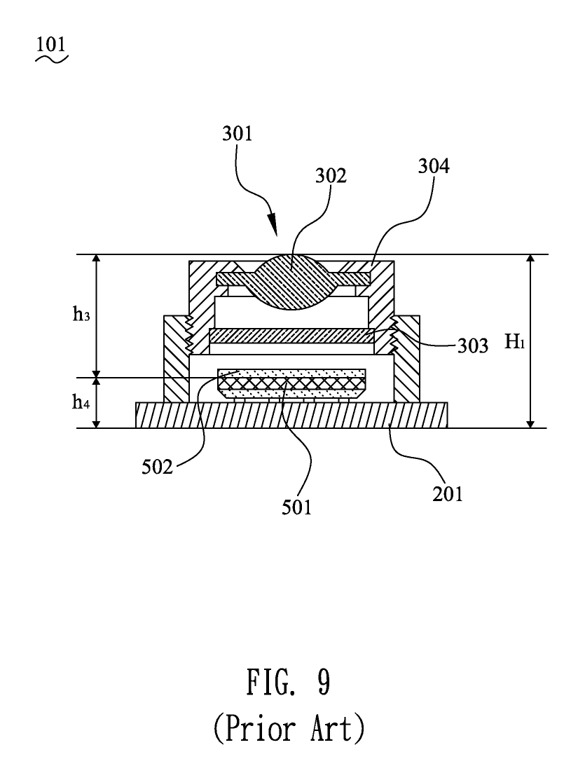

FIG. 10 is a sectional view of a camera module in a second prior art; and

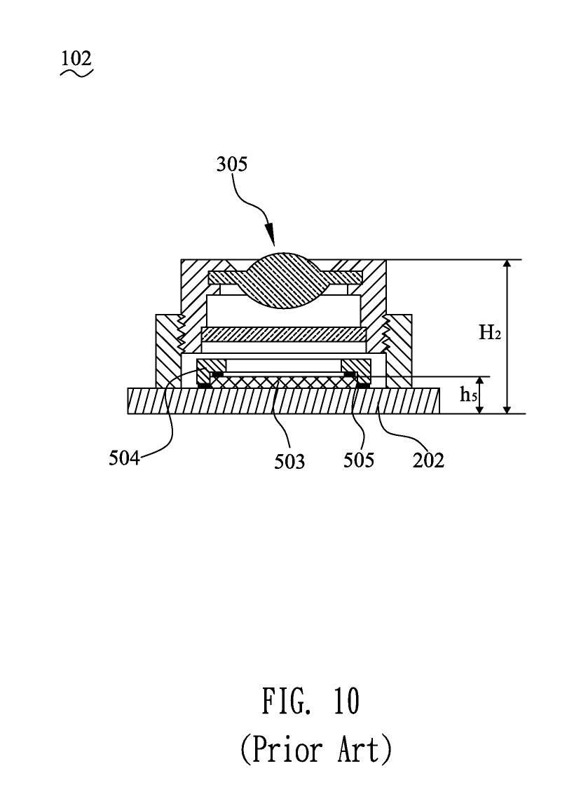

FIG. 11 is a sectional view of a camera module in a third prior art.

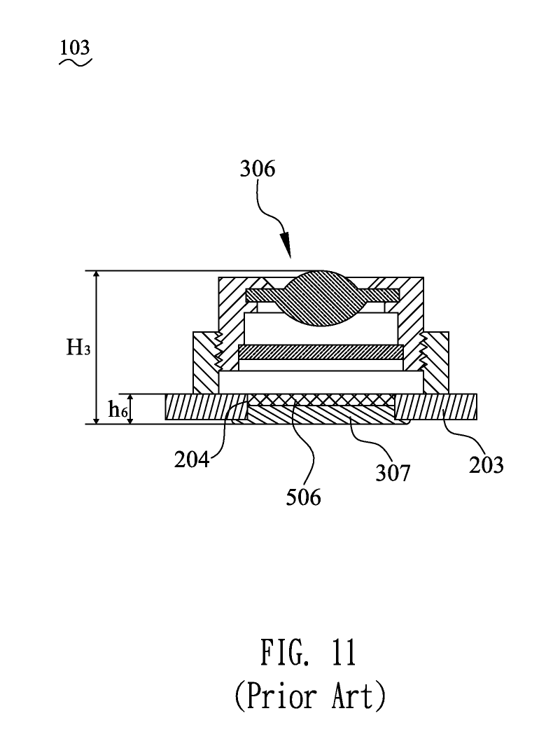

### DETAILED DESCRIPTION OF THE PREFERRED EMBODIMENT

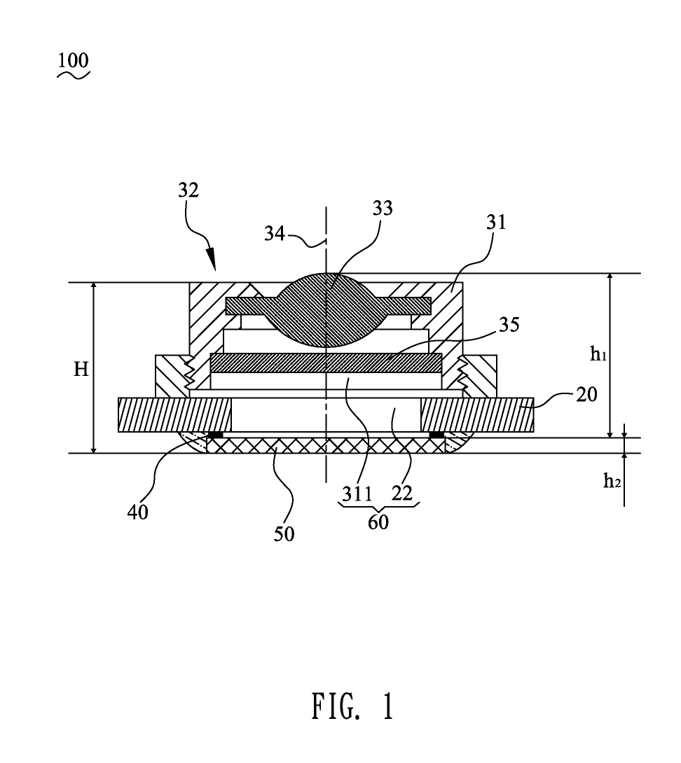

With reference to FIG. 1, a camera module 100 in accordance with a first embodiment of the present invention is shown. The camera module 100 in accordance with the first embodiment of the present invention includes a circuit board 20, a lens socket 31, a lens assembly 32 and an image-sensing chip 50. The circuit board 20 defines a nonopaque area 22. The lens socket 31 is mounted on a top surface of the circuit board 20 and covers the nonopaque area 22. The lens assembly 32 is assembled in the lens socket 31. The lens assembly 32 includes at least one imaging lens 33 which makes an optical axis 34 formed by the lens assembly 32 penetrate through the nonopaque area 22. The image-sensing chip 50 is fastened to a bottom surface of the circuit board 20, and is electrically connected with the circuit board 20. The image-sensing chip 50 is located at the optical axis 34.

Referring to FIG. 1, a height h₁ between a top end of the lens assembly 32 and a top surface of the image-sensing chip 50 need maintain a predetermined height on account of an optical design limitation of the lens assembly 32, so the circuit board 20 is disposed between the lens assembly 32 and the image-sensing chip 50 for effectively decreasing a height h₂ between a bottom surface of the camera module 100 and the top surface of the image-sensing chip 50. So a total height H of the camera module 100 is decreased. So the camera module 100 easily satisfies a thickness requirement of a current portable electronic device (not shown).

Referring to FIG. 1, in the first embodiment, the circuit board 20 is of a hollow frame shape. The nonopaque area 22 is a perforation defined in a middle of the circuit board 20. The camera module 100 further includes a filter 35 disposed inside the lens socket 31. The filter 35 is disposed on the optical axis 34 formed by the lens assembly 32, so light beams through the lens assembly 32 will firstly pass through the filter 35, and then reach the image-sensing chip 50 for further improving an imaging quality. The filter 35 is without being limited to be disposed inside the lens socket 31. Specifically, the lens socket 31 defines a receiving chamber 311 penetrating through a top surface and a bottom surface of the lens socket 31. When the lens socket 31 is mounted on the top surface of the circuit board 20, the receiving chamber 311 is communicated with the nonopaque area 22 to form an accommodating space 60. The imaging lens 33 is received in the receiving chamber 311 with a top of the imaging lens 33 projecting beyond the top surface of the lens socket 31. The filter 35 is received in the receiving chamber 311 of the accommodating space 60 and is located under the imaging lens 33. The filter 35 is spaced from the top surface of the circuit board 20.

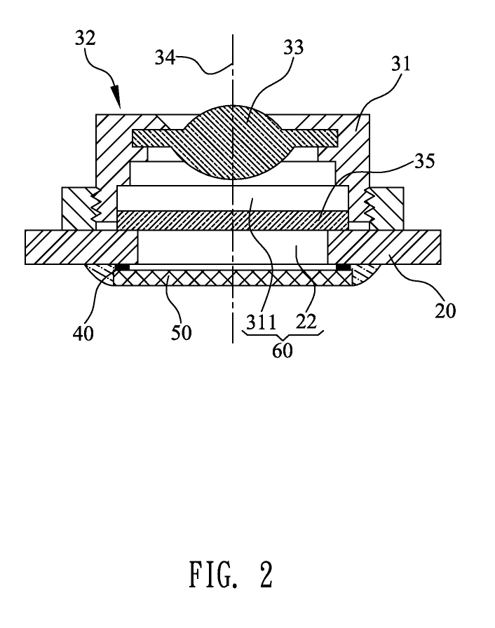

Referring to FIG. 2, a camera module 100 in accordance with a second embodiment of the present invention is shown. A difference between the first embodiment and the second embodiment is described as follows. The filter 35 is adhered to the top surface of the circuit board 20, so the light beams through the lens assembly 32 are capable of passing through the filter 35.

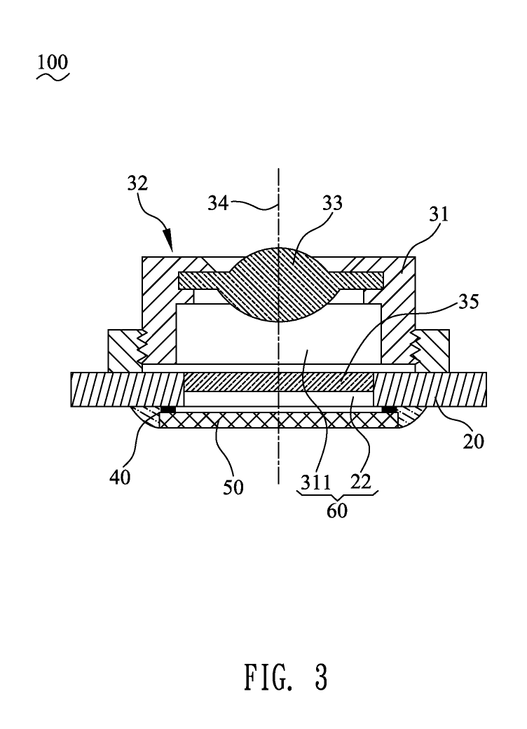

Referring to FIG. 3, a camera module 100 in accordance with a third embodiment of the present invention is shown. A difference between the first embodiment and the third embodiment are described as follows. The filter 35 is disposed in the nonopaque area 22 of the accommodating space 60, so the light beams through the lens assembly 32 are capable of passing through the filter 35. In the first embodiment, the second embodiment and the third embodiment, the filter 35 is disposed in the accommodating space 60 formed between the lens socket 31 and the circuit board 20, so an extra height of the camera module 100 will be without being increased.

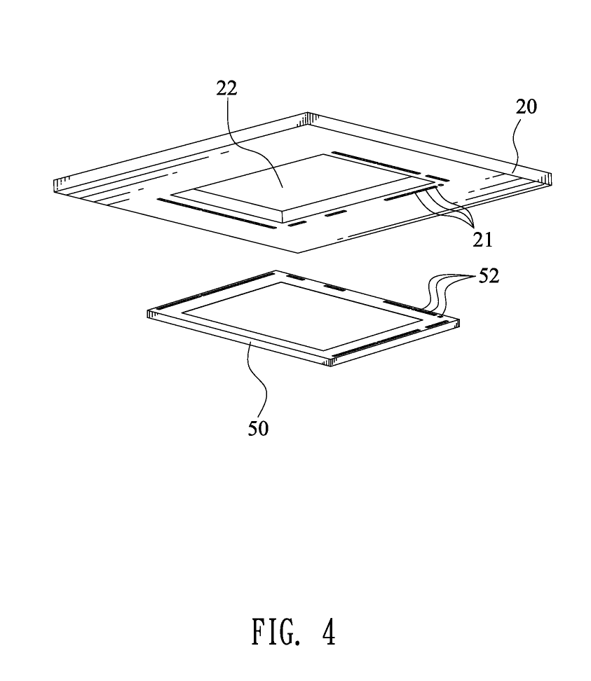

Referring to FIG. 4, in order to make the image-sensing chip 50 electrically connected with the circuit board 20, the top surface of the image-sensing chip 50 is equipped with a plurality of contact points 52. A bottom surface of the circuit board 20 is equipped with a plurality of conductive pads 21 corresponding to the contact points 52. The contact points 52 are electrically connected with the conductive pads 21 by virtue of a conductive material 40, so that the image-sensing chip 50 is electrically connected with the circuit board 20. The conductive material 40 is an anisotropic conductive adhesive. The contact points 52 are distributed on the top surface of the image-sensing chip 50 adjacent to an outer periphery of the image-sensing chip 50. The conductive pads 21 are distributed at the bottom surface of the circuit board 20 and adjacent to an inner periphery of the circuit board 20.

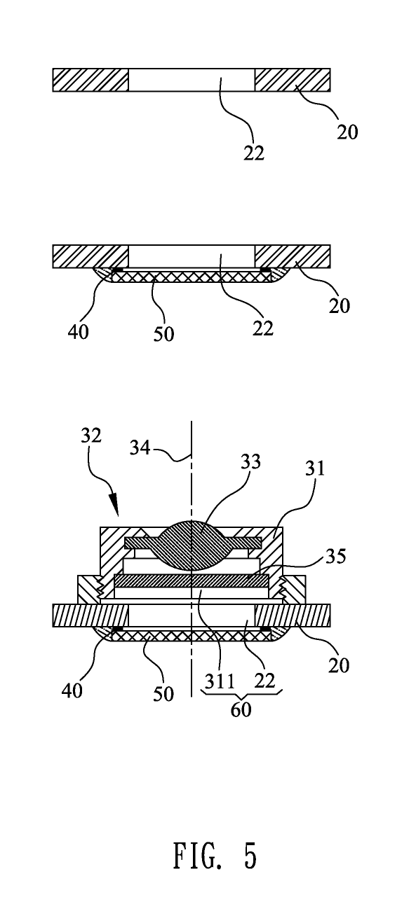

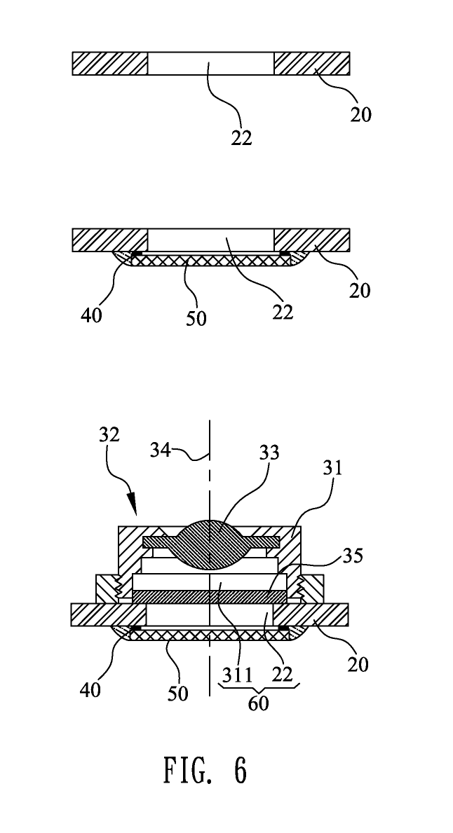

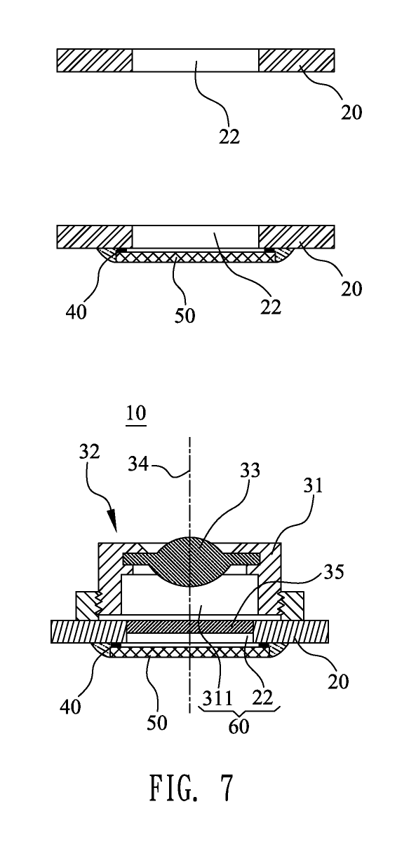

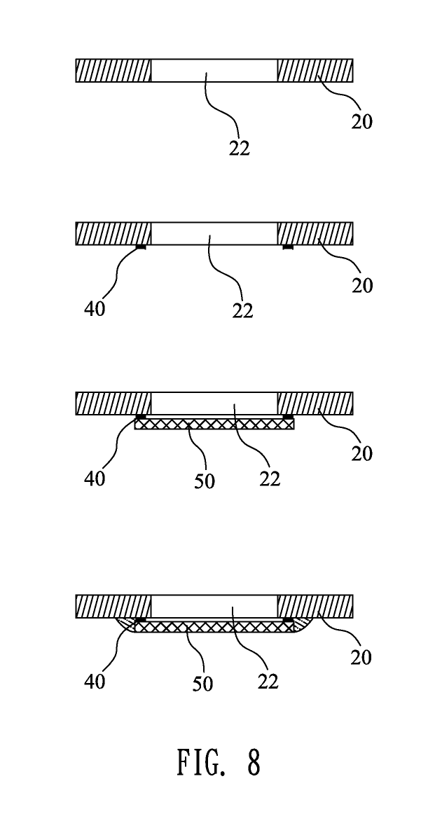

Referring to FIG. 1 to FIG. 8, specific steps of a method for manufacturing the camera module 100 in accordance with the present invention are described as follows.

Prepare the circuit board 20. The circuit board 20 defines the nonopaque area 22, and then predetermined electronic components (not shown) are soldered on the circuit board 20.

Prepare the image-sensing chip 50. The image-sensing chip 50 is assembled to the bottom surface of the circuit board 20 to make the image-sensing chip 50 electrically connected with the circuit board 20 and corresponding to the nonopaque area 22.

Prepare the lens socket 31 and the lens assembly 32. The lens assembly 32 is assembled in the lens socket 31. The lens socket 31 is mounted to the top surface of the circuit board 20 to make the optical axis 34 formed by the lens assembly 32 pass through the nonopaque area 22.

In the step of the image-sensing chip 50 being assembled to the bottom surface of the circuit board 20, the bottom surface of the circuit board 20 is equipped with a plurality of the conductive pads 21. The conductive material 40 is coated on the conductive pads 21. The top surface of the image-sensing chip 50 is equipped with a plurality of the contact points 52. After the conductive pads 21 are corresponding to the contact points 52, the circuit board 20 and the image-sensing chip 50 are pressurized and heated to make an electric conduction between the image-sensing chip 50 and the circuit board 20 by virtue of the conductive material 40.

After the lens assembly 32 is assembled in the lens socket 31, prepare the filter 35. The lens socket 31 defines the receiving chamber 311 penetrating through the top surface and the bottom surface of the lens socket 31. When the lens socket 31 is mounted on the top surface of the circuit board 20, the receiving chamber 311 is communicated with the nonopaque area 22 to form the accommodating space 60. The filter 35 is disposed in the accommodating space 60.

As described above, the circuit board 20 is disposed between the lens assembly 32 and the image-sensing chip 50 of the camera module 100, so the total height H of the camera module 100 is decreased. As a result, the camera module 100 easily satisfies the thickness requirement of the current portable electronic device.

What is claimed is:

1. A camera module, comprising:
a circuit board defining a nonopaque area;
a lens socket mounted on a top surface of the circuit board and covering the nonopaque area;
a lens assembly assembled in the lens socket, the lens assembly including at least one imaging lens which makes an optical axis formed by the lens assembly penetrate through the nonopaque area; and
an image-sensing chip fastened to a bottom surface of the circuit board and electrically connected with the circuit board, the image-sensing chip being located at the optical axis.

2. The camera module as claimed in claim 1, wherein the nonopaque area is a perforation defined in a middle of the circuit board.

3. The camera module as claimed in claim 1, further comprising a filter, the lens socket defining a receiving chamber penetrating through a top surface and a bottom surface of the lens socket, the receiving chamber being communicated with the nonopaque area to form an accommodating space, the filter being disposed in the accommodating space.

4. The camera module as claimed in claim 3, wherein the imaging lens is received in the receiving chamber, the filter is received in the receiving chamber of the accommodating space and is located under the imaging lens.

5. The camera module as claimed in claim 4, wherein the filter is spaced from the top surface of the circuit board.

6. The camera module as claimed in claim 4, wherein the filter is adhered to the top surface of the circuit board.

7. The camera module as claimed in claim 3, wherein the filter is disposed in the nonopaque area of the accommodating space.

8. The camera module as claimed in claim 1, wherein a top surface of the image-sensing chip is equipped with a plurality of contact points, the bottom surface of the circuit board is equipped with a plurality of conductive pads corresponding to the contact points, the contact points are electrically connected with the conductive pads by virtue of a conductive material.

9. The camera module as claimed in claim 8, wherein the conductive material is an anisotropic conductive adhesive.

10. The camera module as claimed in claim 8, wherein the contact points are distributed on the top surface of the image-sensing chip adjacent to an outer periphery of the image-sensing chip, the circuit board is of a hollow frame shape, the conductive pads are distributed at the bottom surface of the circuit board and adjacent to an inner periphery of the circuit board.

11. A method for manufacturing a camera module, comprising the steps of:
preparing a circuit board, the circuit board defining a nonopaque area;
preparing an image-sensing chip, the image-sensing chip being assembled to a bottom surface of the circuit board to make the image-sensing chip electrically connected with the circuit board and corresponding to the nonopaque area; and
preparing a lens socket and a lens assembly, the lens assembly being assembled in the lens socket, the lens socket being mounted to a top surface of the circuit board to make an optical axis formed by the lens assembly pass through the nonopaque area.

12. The method for manufacturing the camera module as claimed in claim 11, wherein in the step of the image-sensing chip being assembled to the bottom surface of the circuit board, the bottom surface of the circuit board is equipped with a plurality of conductive pads, a conductive material is coated on the conductive pads, a top surface of the image-sensing chip is equipped with a plurality of contact points, after the conductive pads are corresponding to the contact points, the circuit board and the image-sensing chip are pressurized and heated to make an electric conduction between the image-sensing chip and the circuit board by virtue of the conductive material.

13. The method for manufacturing the camera module as claimed in claim 12, wherein the conductive material is an anisotropic conductive adhesive.

14. The method for manufacturing the camera module as claimed in claim 12, wherein the contact points are distributed on the top surface of the image-sensing chip adjacent to an outer periphery of the image-sensing chip, the circuit board is of a hollow frame shape, the conductive pads are distributed at the bottom surface of the circuit board and adjacent to an inner periphery of the circuit board.

15. The method for manufacturing the camera module as claimed in claim 11, wherein after the lens assembly is assembled in the lens socket, prepare a filter, the lens socket defines a receiving chamber penetrating through a top surface and a bottom surface of the lens socket, when the lens socket is mounted on the top surface of the circuit board, the receiving chamber is communicated with the nonopaque area to form the accommodating space, the filter is disposed in the accommodating space.

16. The method for manufacturing the camera module as claimed in claim 15, wherein the lens assembly includes at least one imaging lens, the imaging lens is received in the receiving chamber with a top of the imaging lens projecting beyond the top surface of the lens socket, the filter is received in the receiving chamber of the accommodating space and is located under the imaging lens.

17. The method for manufacturing the camera module as claimed in claim 16, wherein the filter is spaced from the top surface of the circuit board.

18. The method for manufacturing the camera module as claimed in claim 16, wherein the filter is adhered to the top surface of the circuit board.

19. The method for manufacturing the camera module as claimed in claim 16, wherein the filter is disposed in the nonopaque area of the accommodating space.
